(19) United States
(12) Patent Application Publication
(10) Pub. No.: US 2026/0059077 A1
(43) Pub. Date: Feb. 26, 2026

(54) LASER PROJECTION APPARATUS AND IMAGE DISPLAY METHOD THEREFOR

(71) Applicant: Hisense Laser Display Co., Ltd, Qingdao City (CN)

(72) Inventors: Zhiyuan LI, Qingdao City (CN); Yishi ZHAO, Qingdao City (CN); Libo GAO, Qingdao City (CN); Xinjian ZHANG, Qingdao City (CN)

(73) Assignee: Hisense Laser Display Co., Ltd, Qingdao City (CN)

(21) Appl. No.: 19/372,702

(22) Filed: Oct. 29, 2025

Related U.S. Application Data
(63) Continuation of application No. PCT/CN2024/100190, filed on Jun. 19, 2024.

(30) Foreign Application Priority Data
Aug. 21, 2023 (CN) 202311056548.3
Aug. 21, 2023 (CN) 202311056608.1
Aug. 21, 2023 (CN) 202311056617.0

(51) Int. Cl. H04N 9/31; G03B 21/00; G03B 21/20

(52) U.S. Cl. CPC H04N 9/3123; G03B 21/008; G03B 21/2013; G03B 21/2033; H04N 9/3138; H04N 9/3161; H04N 9/3188; H04N 9/3194

(57) ABSTRACT

A laser projection apparatus and an image display method of the laser projection apparatus are provided. The laser projection apparatus includes a main control chip, a display driving assembly, a laser source assembly, a laser driving assembly, a video processing assembly, a phase light modulation assembly, and a first light modulation device. The display driving assembly is configured to send a synchronization signal to the phase light modulation assembly and a first driving signal to the first light modulation device according to a video signal. The laser driving assembly is configured to send a second driving signal to the laser source assembly. The video processing assembly is configured to send a phase video signal to the phase light modulation assembly according to the video signal. The phase light modulation assembly is configured to perform phase modulation according to the phase video signal and the synchronization signal.

### CROSS-REFERENCE TO RELATED APPLICATIONS

This application is a continuation application of International Patent Application No. PCT/CN2024/100190, filed on Jun. 19, 2024, which claims priority to Chinese Patent Application Numbers 202311056548.3, 202311056608.1, and 202311056617.0, all filed on Aug. 21, 2023, which are incorporated herein by reference in their entireties.

### TECHNICAL FIELD

The present disclosure relates to the field of projection display, and in particular, to a laser projection apparatus and an image display method of the laser projection apparatus.

### BACKGROUND

Laser projection apparatuses, as a new generation of projection display technology, use laser beams as a laser source and display images through digital light processing (DLP) technology. Moreover, the laser projection apparatuses have the advantages of energy conservation, eye protection, and bright colors.

### SUMMARY

In an aspect, a laser projection apparatus is provided. The laser projection apparatus includes a main control chip, a display driving assembly, a laser source assembly, a laser driving assembly, a video processing assembly, a phase light modulation assembly, and a first light modulation device. The main control chip is configured to generate a video signal according to an external video source. The display driving assembly is connected to the main control chip, the phase light modulation assembly, and the first light modulation device. The display driving assembly is configured to obtain the video signal, send a synchronization signal to the phase light modulation assembly and send a first driving signal to the first light modulation device according to the video signal. The laser source assembly is configured to emit laser beams of a plurality of primary colors. The laser driving assembly is connected to the laser source assembly. The laser driving assembly is configured to obtain the synchronization signal and send a second driving signal to the laser source assembly according to the synchronization signal, so as to drive the laser source assembly to be turned on to emit the laser beams of the plurality of primary colors. The video processing assembly is connected to the main control chip and the phase light modulation assembly. The video processing assembly is configured to receive the video signal sent by the main control chip and send a phase video signal to the phase light modulation assembly according to the video signal. The phase light modulation assembly is configured to perform phase modulation according to the phase video signal and the synchronization signal, so as to output first modulated beams to the first light modulation device. The first light modulation device is configured to modulate the first modulated beams to obtain second modulated beams, so as to project the second modulated beams for display.

In another aspect, an image display method of a laser projection apparatus is provided. The laser projection apparatus includes a main control chip, a display driving assembly, a laser source assembly, a laser driving assembly, a video processing assembly, a phase light modulation assembly, and a first light modulation device. The display driving assembly is connected to the main control chip, the laser driving assembly, the phase light modulation assembly and the first light modulation device. The laser source assembly is configured to emit laser beams of a plurality of primary colors. The laser driving assembly is connected to the laser source assembly. The video processing assembly is connected to the main control chip and the phase light modulation assembly. The phase light modulation assembly is configured to perform phase modulation on the laser beams of the plurality of primary colors to provide first modulated beams. The first light modulation device is configured to modulate the first modulated beams. The method includes: obtaining, by the display driving assembly, a video signal, and sending a synchronization signal to the laser driving assembly and the phase light modulation assembly and sending a first driving signal to the first light modulation device according to the video signal; determining, by the laser driving assembly, a second driving signal according to the synchronization signal, and driving the laser source assembly to be turned on according to the second driving signal, so as to emit the laser beams of the plurality of primary colors to the phase light modulation assembly; obtaining, by the video processing assembly, luminance compensation parameters, and sending a phase video signal to the phase light modulation assembly according to the luminance compensation parameters and the video signal; obtaining, by the phase light modulation assembly, a bias voltage according to the synchronization signal, and performing phase modulation according to the phase video signal and the bias voltage, so as to output the first modulated beams to the first light modulation device; and modulating, by the first light modulation device, the first modulated beams to display an image.

### BRIEF DESCRIPTION OF THE DRAWINGS

FIG. 1 is a schematic diagram of high-dynamic range (HDR) display, in accordance with some embodiments;

FIG. 2 is a schematic diagram of high dynamic range display performed by a phase light modulation device coupled with a three-piece amplitude light modulation device, in accordance with some embodiments;

FIG. 3 is a schematic diagram of another high-dynamic range (HDR) display, in accordance with some embodiments;

FIG. 4 is a schematic diagram of high dynamic range display performed by a single-piece phase light modulation device coupled with a single-piece amplitude light modulation device, in accordance with some embodiments;

FIG. 5 is a diagram showing a structure of a laser projection apparatus, in accordance with some embodiments;

FIG. 6 is a diagram showing a structure of a digital micromirror device, in accordance with some embodiments;

FIG. 7 is a schematic diagram showing a swing position of a micromirror, in accordance with some embodiments;

FIG. 8 is a flow chart of steps performed by a phase retrieval algorithm, in accordance with some embodiments;

FIG. 9 is a diagram showing a structure of another laser projection apparatus, in accordance with some embodiments;

FIG. 10 is a diagram showing a structure of a video processing assembly, in accordance with some embodiments;

FIG. 11 is a diagram showing a structure of another video processing assembly, in accordance with some embodiments;

FIG. 12 is a schematic diagram of first luminance correction parameters and image regions, in accordance with some embodiments;

FIG. 13 is a schematic diagram of a target matrix, in accordance with some embodiments;

FIG. 14 is a diagram showing a structure of yet another laser projection apparatus, in accordance with some embodiments;

FIG. 15 is a schematic diagram showing a synchronization relationship between a laser source assembly, a second light modulation device, and a first light modulation device, in accordance with some embodiments;

FIG. 16 is a diagram showing a structure of a phase light modulation assembly, in accordance with some embodiments;

FIG. 17A is a diagram showing a structure of a bias voltage conversion circuit, in accordance with some embodiments;

FIG. 17B is a diagram showing a structure of another bias voltage conversion circuit, in accordance with some embodiments;

FIG. 18 is a diagram showing a structure of yet another bias voltage conversion circuit, in accordance with some embodiments;

FIG. 19 is a waveform diagram of an enable signal and a bias voltage, in accordance with some embodiments;

FIG. 20 is a schematic diagram of adjusting a latency of an enable signal corresponding to a subsequent laser beam with a primary color in the presence of a latency, in accordance with some embodiments;

FIG. 21 is a schematic diagram of a bias voltage signal that is not superimposed with a preset voltage signal and a bias voltage signal superimposed with the preset voltage signal, in accordance with some embodiments;

FIG. 22 is a waveform diagram of an enable signal and a bias voltage signal superimposed with a preset voltage signal, in accordance with some embodiments;

FIG. 23 is a flow chart of an image display method of a laser projection apparatus, in accordance with some embodiments; and

FIG. 24 is another flow chart of an image display method of a laser projection apparatus, in accordance with some embodiments.

### DETAILED DESCRIPTION

Some embodiments of the present disclosure will be clearly and completely described below with reference to the accompanying drawings. However, the described embodiments are merely some but not all embodiments of the present disclosure. All other embodiments obtained by a person of ordinary skill in the art based on embodiments of the present disclosure shall be included in the protection scope of the present disclosure.

Unless the context requires otherwise, throughout the description and the claims, the term “comprise” and other forms thereof such as the third-person singular form “comprises” and the present participle form “comprising” are construed as an open and inclusive meaning, i.e., “including, but not limited to.” In the description, the terms such as “one embodiment,” “some embodiments,” “exemplary embodiments,” “example,” “specific example,” or “some examples” are intended to indicate that specific features, structures, materials, or characteristics related to the embodiment(s) or example(s) are included in at least one embodiment or example of the present disclosure. Schematic representations of the above terms do not necessarily refer to the same embodiment(s) or example(s). In addition, the specific features, structures, materials, or characteristics may be included in any one or more embodiments or examples in any suitable manner.

Hereinafter, the terms such as “first” and “second” are used for descriptive purposes only and are not to be construed as indicating or implying the relative importance or implicitly indicating the number of indicated technical features. Thus, features defined by “first” or “second” may explicitly or implicitly include one or more of the features. In the description of the embodiments of the present disclosure, the term “a plurality of” or “the plurality of” means two or more unless otherwise specified.

In the description of some embodiments, the term “connected” and derivative thereof may be used. The term “connected” should be understood in a broad sense. For example, the term “connected” may represent a fixed connection, a detachable connection, or a one-piece connection, or may represent a direct connection, or may represent an indirect connection through an intermediate medium. The embodiments disclosed herein are not necessarily limited to the content herein.

The phrase “at least one of A, B, and C” has the same meaning as the phrase “at least one of A, B, or C,” both including the following combinations of A, B, and C: only A, only B, only C, a combination of A and B, a combination of A and C, a combination of B and C, and a combination of A, B, and C.

The use of the phase “applicable to” or “configured to” herein means an open and inclusive expression, which does not exclude devices that are applicable to or configured to perform additional tasks or steps.

The terms such as “about,” “substantially,” and “approximately” as used herein include a stated value and an average value within an acceptable range of deviation of a particular value. The acceptable range of deviation is determined by a person of ordinary skill in the art, considering measurement in question and errors associated with measurement of a particular quantity (i.e., limitations of a measurement system).

The term such as “parallel,” “perpendicular,” or “equal” as used herein includes a stated condition and a condition similar to the stated condition. A range of the similar condition is within an acceptable deviation range, and the acceptable deviation range is determined by a person of ordinary skill in the art, considering measurement in question and errors associated with measurement of a particular quantity (i.e., the limitations of a measurement system).

Generally, when a laser projection apparatus performs projection display, the laser projection apparatus is limited by a laser source assembly and cannot achieve local backlight adjustment and high-dynamic range (HDR) display by adjusting luminance of lamp beads in different regions like backlight liquid crystal display.

In some manners, the laser projection apparatus may achieve HDR display through the following two manners.

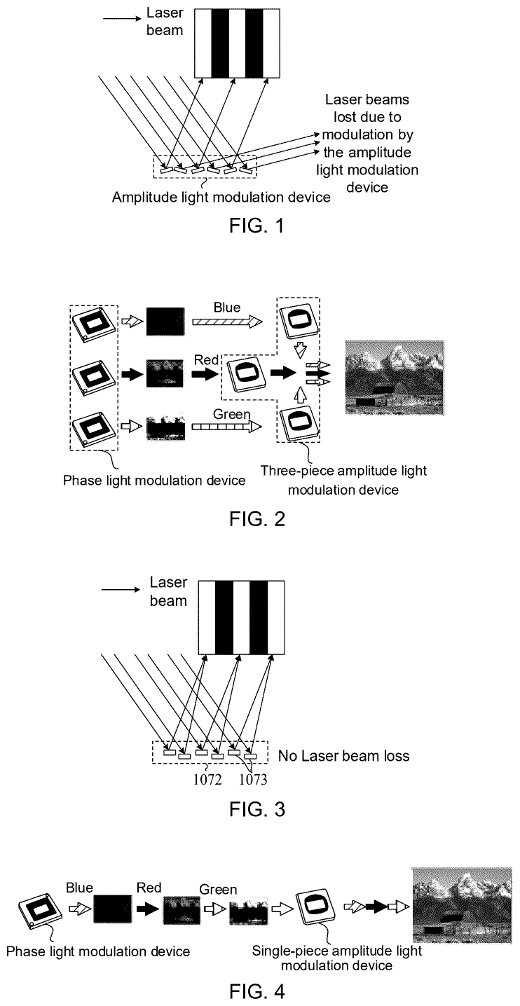

In the first manner, an additional amplitude light modulation device is added. Laser beams output by the laser source assembly are modulated by a first amplitude light modulation device, then irradiated onto a second amplitude light modulation device, and modulated by the second amplitude light modulation device, so as to achieve projection display. As shown in FIG. 1, laser beams corresponding to a dark field are discarded and laser beams corresponding to a bright field are reflected to the second amplitude light modulation device for projection display after the laser beams are modulated by the first amplitude light modulation device, so that the HDR display is achieved by greatly reducing luminance of the dark field. However, such manner has low luminous efficacy, poor practicality, and cannot increase peak luminance.

Here, the term “peak luminance” may be understood as maximum luminance that a screen can support within a short period of time. The term “dark field” may be understood as an image of an object captured by a camera when light reflected by the object does not enter the camera. The term “bright field” may be understood as an image of an object captured by a camera when light reflected by the object enters the camera.

In the second manner, as shown in FIG. 2, for the three-piece amplitude light modulation device technology, phase light modulation devices are added to modulate laser beams of each primary color to be incident on the amplitude light modulation device, thereby achieving large-scale local adjustment of the displayed image. Moreover, luminance of the dark field may be reduced and peak luminance may be increased through the phase light modulation devices. Moreover, as shown in FIG. 3, since no light is discarded during the modulation process of the phase light modulation device, the manner using the phase light modulation device has the advantage of high luminous efficacy.

Since the laser beams of three primary colors in this manner is required to be combined (e.g., combined into one beam) in space through optical devices for projection display, there is no need to consider additional signal synchronization requirements as long as a display timing and a phase light modulation timing of the laser beams of three primary colors are synchronized with the frames of the video image. However, as shown in FIG. 4, since the display timing of the laser beams of the primary colors is in a form of time division multiplexing in the single-piece amplitude light modulation device technology, the phase light modulation devices cannot be used in the single-piece amplitude light modulation device technology.

Here, the single-piece amplitude light modulation device technology may be understood as using one amplitude light modulation device in the digital light processing (DLP) technology, and the one amplitude light modulation device modulates the laser beams of three primary colors at different times. The three-piece amplitude light modulation device technology may be understood as using three amplitude light modulation devices in the DLP technology, the three amplitude light modulation devices correspond to the laser beams of three primary colors, respectively, and each amplitude light modulation device modulates the laser beams of corresponding primary color.

To this end, a laser projection apparatus is provided in some embodiments of the present disclosure. The laser projection apparatus 10 uses a single phase light modulation device to perform phase modulation on illumination beams output by the laser source assembly, so as to adjust the distribution of light energy in space. Moreover, the laser projection apparatus may achieve synchronization between HDR display and the display timing corresponding to each primary color according to the display timing of each primary color in single-piece amplitude light modulation device technology, thereby increasing peak luminance and reducing luminance of the dark field, improving luminous efficacy, and achieving HDR display.

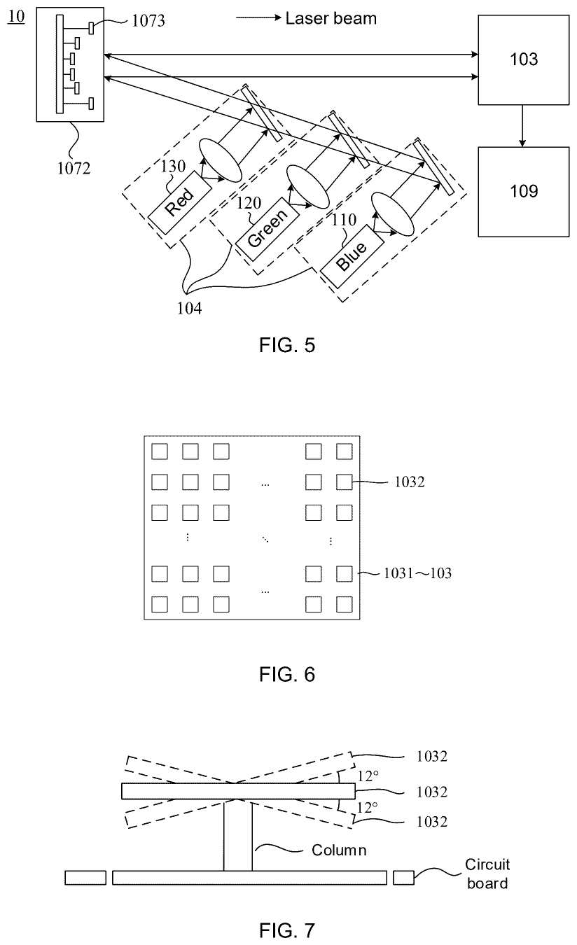

As shown in FIG. 5, the laser projection apparatus 10 includes a laser source assembly 104, a first light modulation device 103 (also referred to as an amplitude light modulation device), and a projection lens 109. The laser source assembly 104 is configured to emit laser beams of a plurality of primary colors. Here, the laser beams of primary colors emitted by the laser source assembly 104 may be referred to as illumination beams. The first light modulation device 103 is configured to modulate the illumination beams provided by the laser source assembly 104, so as to obtain second modulated beams. The projection lens 109 is configured to project the second modulated beams into an image on a screen or a wall.

In some embodiments, the laser source assembly 104 may include a plurality of laser devices. As shown in FIG. 5, in an example where the laser source assembly 104 includes three laser devices, the three laser devices may be a red laser device 130 emitting red laser beams, a green laser device 120 emitting green laser beams, and a blue laser device 110 emitting blue laser beams.

The illumination beams emitted by the laser source assembly 104 enter the first light modulation device 103 (or a light valve). The first light modulation device 103 is configured to modulate the illumination beams to obtain the second modulated beams and reflect the second modulated beams into the projection lens 109, so as to achieve projection display.

In some embodiments, as shown in FIG. 6, the first light modulation device 103 includes a digital micromirror device (DMD) 1031.

The DMD 1031 is a core component and configured to modulate the illumination beams provided by the laser source assembly 104. For example, the digital micromirror device 1031 controls the illumination beams to display different luminance and gray scales according to different pixels in an image to be projected, so as to finally produce an optical image.

The DMD 1031 is applied in the DLP projection architecture. As shown in FIG. 6, the DMD 1031 includes thousands of micromirrors 1032 that may be individually driven to rotate. These micromirrors 1032 are arranged in an array. One micromirror 1032 (e.g., each micromirror 1032) corresponds to one pixel in the image to be projected. In the DLP projection architecture, each micromirror 1032 is equivalent to a digital switch. The micromirror 1032 may swing within a range of plus or minus 12° (i.e., ±12°) or a range of plus or minus 17° (i.e., ±17°) due to an action of an external electric field, so that the reflected laser beam may be imaged on the screen along an optical axis direction by the projection lens 109, forming a bright pixel.

For example, as shown in FIG. 7, for the micromirrors 1032 with the deflection angles of ±12°, a state at +12° is an ON state, and a state at −12° is an OFF state. For a deflection angle between −12° and +12°, actual operating states of the micromirror 1032 are only the ON state and the OFF state. A laser beam reflected by the micromirror 1032 at a negative deflection angle is referred to as an OFF laser beam, and the OFF laser beam is an ineffective laser beam. The ineffective laser beam usually irradiates on a housing of the laser projection apparatus 10, or irradiates on a laser absorption portion and absorbed by the laser absorption portion. A laser beam reflected by the micromirror 1032 at a positive deflection angle is referred to as an ON laser beam. The ON laser beam is an effective beam reflected by the micromirror 1032 on a surface of the DMD 1031 when the micromirror 1032 receives irradiation of the illumination beams, and the reflected ON laser beam enters the projection lens 109 at a positive deflection angle for projection imaging. In a display cycle of a frame of an image, some or all of the micromirrors 1032 are switched at least once between the ON state and the OFF state, so that gray scales of pixels in a frame of an image are achieved according to durations of the micromirrors 1032 in the ON state and the OFF state.

In some embodiments, as shown in FIG. 5, the laser projection apparatus 10 further includes a second light modulation device 1072 (also referred to as a phase light modulation device). The second light modulation device 1072 is located on a beam path between the laser source assembly 104 and the first light modulation device 103, and is configured to perform phase modulation on the incident illumination beams to obtain first modulated beams, and output the first modulated beams to the first light modulation device 103, thereby achieving HDR display. In consideration of convenience, the illumination beams after the phase modulation are referred to as first modulated beams, and the beams modulated by the first light modulation device 103 are referred to as second modulated beams.

In some embodiments, the second light modulation device 1072 may be a light phase modulator.

The principle of HDR display achieved by the second light modulation device 1072 is described below.

As shown in FIG. 3, the second light modulation device 1072 is a component including a plurality of mirrors 1073 having a micron-level size. A reflective surface of the mirror 1073 is a plane, and the mirror 1073 may move in a direction perpendicular to the reflective surface (e.g., moving up and down), so that a phase relationship among the laser beams incident on the mirrors 1073 may be changed by the up-down movement of the mirrors 1073. Since the laser beams are coherent light, diffraction may occur after the phases of the laser beams are changed, so that the light intensity distribution of an image may be adjusted. For example, in actual display effects, laser beams in dark regions (e.g., dark fields) in an image may be “moved” to bright regions (e.g., bright fields), so as to increase luminance of the bright regions and reduce luminance of the dark regions, thereby achieving high dynamic range display.

In this way, HDR display may be achieved by a second light modulation device 1072 coupled with a first light modulation device 103.

For example, as shown in FIG. 5, the laser source assembly 104 emits laser beams of three primary colors in sequence. When the laser beams of a single color are irradiated onto the second light modulation device 1072, the second light modulation device 1072 may perform phase modulation on the monochromatic laser beams according to the image to be displayed. The mirrors 1073 corresponding to the pixels in the image to be displayed is displaced to change the phase of the monochromatic laser beams. The modulated laser beams are incident on the first light modulation device 103. The diffraction beams corresponding to a region with high luminance in the image to be displayed have high intensity, and the diffraction beams corresponding to a region with low luminance in the image to be displayed have low intensity. The diffraction beams are modulated by the pulse width modulation (PWM) of the first light modulation device 103 and then projected into an image on a screen by the projection lens 109, so that HDR display is achieved.

At least two laser beams of the illumination beams modulated by the second light modulation device 1072 have different light intensities, so that a luminance difference between at least two regions in the projection image may be expanded. In this way, the dynamic contrast of the projection image may be improved without changing luminance of the illumination beams output by the laser source assembly 104 or processing the projection image, thereby improving the display effect of the image subsequently projected by the projection lens 109.

The second light modulation device 1072 is required to be controlled according to phase information of the light field. Since the phase information cannot be measured, it is necessary to use a phase retrieval algorithm to obtain the phase information. The phase information of the light field is iteratively calculated (i.e., multiple constraints, substitutions, and re-transformations are performed in the spatial domain and spectral domain) through diffraction calculation according to known light field amplitude (e.g., intensity) information (i.e., a transformation relationship between two light fields being known) of an input plane (e.g., an image plane) and an output plane (e.g., a plane of far-field diffraction (i.e., Fraunhofer diffraction) or a surface of the first light modulation device 103).

The phase retrieval algorithm is described below by considering the Gerchberg-Saxtong (GS) algorithm as an example.

A light wave function f(x,y) of an input plane of the illumination beams output by the laser source assembly 104 at the second light modulation device 1072 may be expressed as the following:

$$f ( x , y ) = A ( x , y ) exp ( i Φ ( x , y ) ) \qquad ( 1 )$$

The “A(x,y)” represents an amplitude distribution of the light field at the second light modulation device 1072, and the “ϕ(x,y)” represents a phase distribution of the light field at the second light modulation device 1072. The amplitude distribution A(x,y) is known, and the phase distribution ϕ(x,y) may be estimated in the first calculation. The “(x,y)” represents point coordinates on the input plane.

An amplitude distribution and a phase distribution at an output plane may be expressed by a light wave function g(u,v) of the output plane after phase modulation:

$$g ( u , v ) = B ( u , v ) exp ( i θ ( u , v ) ) \qquad ( 2 )$$

The “B(u,v)” represents an amplitude distribution of the illumination beams after phase modulation. The “6(u,v)” represents a phase distribution of the illumination beams after phase modulation. The “(u,v)” represents point coordinates of the illumination beams on the output plane after phase modulation. Since the light intensity of the modulated illumination beams depends on a video signal, the amplitude distribution B(u,v) is known.

The light wave functions f(x,y) and g(u,v) meet the following transformation conditions:

$$g ( u , v ) = F ( f ( x , y ) ) , f ( x , y ) = F - 1 ( g ( u , v ) ) \qquad ( 3 )$$

The “F” represents Fourier transform, and the “F−1” represents inverse Fourier transform. Therefore, the light wave function of the output plane may be obtained by performing the Fourier transform on the light wave function of the input plane, and the light wave function of the input plane may be obtained by performing the inverse Fourier transform on the light wave function of the output plane.

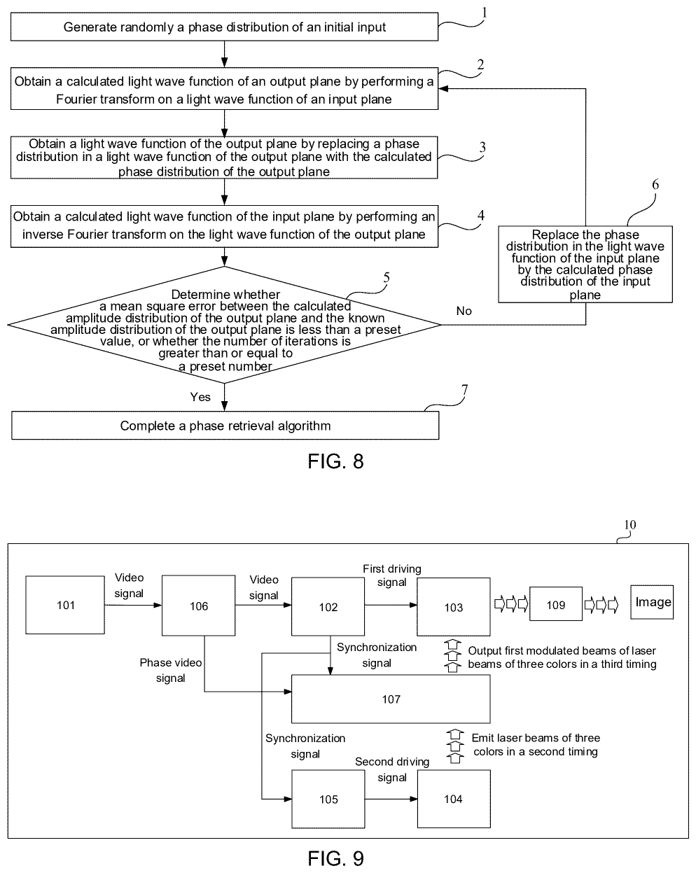

In summary, as shown in FIG. 8, the process of the GS algorithm is as follows.

In step 1, a phase distribution ϕ0(x,y) of the initial input is randomly generated. In this case, the light wave function of the input plane may be obtained according to the known amplitude distribution A(x,y) of the input plane and the phase distribution ϕ0(x,y) of the initial input (i.e., f(x,y)=A(x,y)exp(iϕ0(x,y))).

In step 2, a calculated light wave function g′(u,v) of an output plane is obtained by performing a Fourier transform on a light wave function (i.e., f(x,y)=A(x,y)exp(iϕ0(x,y))) of an input plane. Here, since the calculated light wave function g′(u,v) of the output plane is equal to B′(u,v)exp(iθn(u,v)) (i.e., g′(u,v)=B′(u,v)exp(iθn(u,v))), the calculated phase distribution θn(u,v) of the output plane may be obtained. It will be noted that B′(u,v) is the calculated amplitude distribution of the output plane. The lowercase letter “n” is the number of cycles.

In step 3, a light wave function of the output plane is obtained by replacing a phase distribution in the light wave function g(u,v) of the output plane with the calculated phase distribution θn(u,v) of the output plane (i.e., g(u,v)=B(u,v)exp(iθn((u,v))).

In step 4, a calculated light wave function f′(x,y) of the input plane is obtained by performing an inverse Fourier transform on the light wave function (i.e., g(u,v)=B(u,v)exp(iθn(u,v))) of the output plane (i.e., f′(x,y)=A′(x,y)exp(iϕn(x,y))). Here, the “ϕn(x,y)” is the calculated phase distribution of the input plane.

In step 5, it is determined whether a mean square error between the calculated amplitude distribution B′(u,v) of the output plane and the known amplitude distribution B(u,v) of the output plane is less than a preset value ε, or whether the number of iterations is greater than or equal to a preset number K. If not, step 6 is performed; if so, step 7 is performed.

Here, the phrase “the number of iterations” may be understood as the number of cycles from step 2 to step 4 that have been executed (e.g., the number of cycles n).

In step 6, the phase distribution in the light wave function f(x,y) of the input plane is replaced by the calculated phase distribution ϕn(x,y) of the input plane, and step 2 is repeated.

In step 7, the phase retrieval algorithm is completed. When the phase retrieval algorithm is completed, the calculated phase distribution ϕk(x,y) of the input plane is a phase distribution function representing the phase information required by the second light modulation device 1072. Here, the lowercase letter “k” represents the number of cycles that have occurred when the phase retrieval algorithm is completed.

FIG. 9 is a diagram showing a structure of a laser projection apparatus, in accordance with some embodiments.

In some embodiments, as shown in FIG. 9, the laser projection apparatus 10 further includes a main control chip 101, a display driving assembly 102, a laser driving assembly 105, a video processing assembly 106 and a phase light modulation assembly 107.

The main control chip 101 is configured to generate a video signal according to an external video source. The external video source may be a network video source, a video signal transmitted by a high definition multimedia interface (HDMI), or a video source in a storage medium such as a USB flash disk. The decoded video signal may be a signal (e.g., a signal corresponding to video-by-one (V-By-One)) corresponding to a digital interface standard developed for image transmission, or a signal corresponding to a low voltage differential signaling (LVDS) interface. Here, decoding the video signals may be understood as decoding the video signal input from an external source, or decoding the video signal into a plurality of video sub-signals as described below, and the present disclosure is not limited thereto.

In some embodiments, the main control chip 101 may be a system on chip (SOC).

The display driving assembly 102 is connected to the main control chip 101, the laser driving assembly 105, the phase light modulation assembly 107 and the first light modulation device 103. The display driving assembly 102 is configured to obtain a video signal, and send a synchronization signal to the laser driving assembly 105 and the phase light modulation assembly 107 and send a first driving signal to the first light modulation device 103 according to the video signal.

The first driving signal is transmitted according to a first timing. For example, if the first timing is a cycle in the order of a red laser beam to a green laser beam to a blue laser beam (i.e., an R-G-B cycle), the first light modulation device 103 displays an image in the order of the red laser beam to the green laser beam to the blue laser beam. In consideration of convenience, the following is described by considering an example in which the capital letter “R” represents the red laser beam, the capital letter “G” represents the green laser beam, and the capital letter “B” represents the blue laser beam.

In some embodiments, the synchronization signal may include an enable signal and a PWM signal. The enable signal may be a signal for controlling the timing and configured to control output timings of the laser beams of different primary colors. The PWM signal may be a square wave signal and configured to provide a current signal for the laser source assembly 104 to emit laser beams.

In consideration of convenience, the enable signal is represented by a reference sign “X_EN”, and the capital letter “X” represents abbreviations of the laser beams of different primary colors. For example, an enable signal corresponding to the red laser beam is R_EN, an enable signal corresponding to the green laser beam is G_EN, and an enable signal corresponding to the blue laser beam is B_EN.

In some embodiments, the display driving assembly 102 may determine the enable signal and the PWM signal according to the video signal.

The display driving assembly 102 may determine image quality of the image to be displayed according to the video signal after receiving the video signal. Then, the display driving assembly 102 may determine the first timing according to the image quality of the image to be displayed, and generate the first driving signal according to regions of the first light modulation device 103 and a bit range of pixels of primary colors.

For example, the display driving assembly 102 includes a third digital-to-analog converter (DAC). The display driving assembly 102 determines the PWM signal according to the video signal, obtains an analog signal corresponding to the PWM signal by performing a digital-to-analog conversion on the PWM signal through the third DAC, and sends the analog signal corresponding to the PWM signal and the enable signal to the laser driving assembly 105.

In some embodiments, the display driving assembly 102 may be a digital light processing chip.

The laser driving assembly 105 is connected to the laser source assembly 104 and configured to send a second driving signal to the laser source assembly 104 according to the synchronization signal, so as to drive the laser source assembly 104 to be turned on to emit the corresponding primary color laser beams. For example, the laser driving assembly 105 generates the second driving signal according to the analog signal corresponding to the PWM signal and the enable signal.

The second driving signal may be transmitted according to a second timing. For example, if the second timing is the R-G-B cycle, the laser source assembly 104 emits laser beams of three primary colors in the order of the red laser beam to the green laser beam to the blue laser beam through the three-color laser device.

The video processing assembly 106 is connected to the main control chip 101 and the phase light modulation assembly 107. The video processing assembly 106 is configured to receive the video signal sent by the main control chip 101 and send a phase video signal to the phase light modulation assembly 107 according to the video signal.

For example, the video processing assembly 106 performs the phase retrieval algorithm on the video signal, so as to generate the phase video signal, so that the phase light modulation assembly 107 may perform phase modulation according to the phase video signal.

In some embodiments, the video processing assembly 106 may include a field programmable gate array (FPGA) chip. Alternatively, the video processing assembly 106 may also include a graphics processing unit (GPU). Moreover, the video processing assembly 106 may also be configured with a memory. The memory may be a double data rate synchronous dynamic random access memory (DDR SDRAM) to cooperate with the FPGA chip or the GPU to achieve large-scale image processing computations.

The phase light modulation assembly 107 includes the second light modulation device 1072 and is configured to perform phase modulation according to the phase video signal and the synchronization signal, so as to output first modulated beams to the first light modulation device 103. The phase video signal and the synchronization signal may be transmitted according to a third timing. For example, if the third timing is the R-G-B cycle, the phase light modulation assembly 107 performs phase modulation in the order of the red laser beam to the green laser beam to the blue laser beam.

In this case, the first light modulation device 103 is configured to modulate the first modulated beams to obtain the second modulated beams and reflect the second modulated beams into the projection lens 109 for projection display, so that HDR display is achieved.

In some embodiments, the first light modulation device 103 is configured to refresh states of the micromirrors 1032 of the first light modulation device 103 according to the first timing, so as to modulate the first modulated beams. The first light modulation device 103 may modulate the received first modulated beams through the micromirrors 1032 that the states have been refreshed, so as to achieve image display.

In some embodiments, the first timing, the second timing, and the third timing are synchronous, and the laser beams of a primary color have a same duration in the plurality of timings. In this way, the light emission of the laser source assembly 104, the image display of the first light modulation device 103, and the phase modulation of the phase light modulation device 107 may be synchronous. Here, the “the laser beams of a primary color have a same duration” may be understood as a same color laser beam has a same duration in different timings.

In some embodiments, since there is a lag in the on and off of the laser device in the laser source assembly 104, the display driving assembly 102 may fine-tune a latency of the first timing, so as to synchronize the first timing with the third timing. For example, the display driving assembly 102 increases the latency of the first timing.

In some embodiments of the present disclosure, when HDR display is achieved, light energy may be redistributed in space through the components described above, so that peak luminance may be increased, luminance of the dark field may be reduced, and luminous efficacy may be improved.

The manner in which the display driving assembly 102 obtains the video signal is described below.

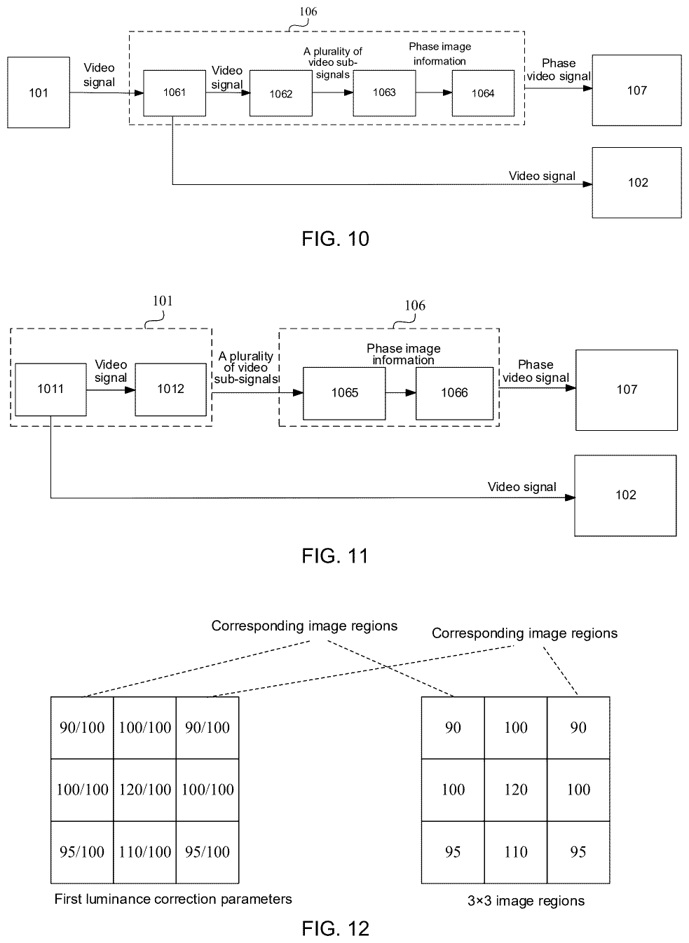

In some embodiments, as shown in FIGS. 9 and 10, the video processing assembly 106 is connected to the display driving assembly 102, and the display driving assembly 102 is configured to receive the video signal sent by the video processing assembly 106. Alternatively, as shown in FIG. 11, the main control chip 101 is connected to the display driving assembly 102, and the display driving assembly 102 is configured to receive the video signal sent by the main control chip 101.

How the video processing assembly 106 generates the phase video signal according to the video signal is described below.

The video signal is usually a multi-channel serial signal, which is required to be decoded to generate a plurality of video sub-signals. That is to say, the plurality of video sub-signals are obtained by decoding the video signal. For example, the plurality of video sub-signals include an R video sub-signal, a G video sub-signal, and a B video sub-signal.

Two decoding manners are described below by examples.

In some examples, the video processing assembly 106 is configured to generate a plurality of video sub-signals according to a video signal. For example, after the video signal is output from a video interface in the main control chip 101 to the video processing assembly 106, the video processing assembly 106 decodes the video signal to obtain an R video sub-signal, a G video sub-signal and a B video sub-signal, and the video processing assembly 106 may store the plurality of video sub-signals in a memory. In this way, the interface link may be simplified.

In some other examples, the main control chip 101 is configured to generate a plurality of video sub-signals according to a video signal, and output the plurality of video sub-signals to the video processing assembly 106. In this way, the computing power requirement of the video processing assembly 106 may be reduced by transferring the decoding operation to the main control chip 101.

After obtaining the plurality of video sub-signals by means of the two manners, the video processing assembly 106 is further configured to: obtain a plurality of video sub-signals after the video signal is decoded into the plurality of video sub-signals; determine a phase information signal corresponding to any one of the video sub-signals according to any one of the video sub-signals; and determine the phase video signal according to the phase information signals corresponding to the plurality of video sub-signals. The phase information signal includes a lot of phase image information.

In some embodiments, as shown in FIG. 10, in a case where the video processing assembly 106 generates the plurality of video sub-signals according to the video signal, the video processing assembly 106 includes a bypass video signal output component 1061, a first sub-frame decoding component 1062, a first phase retrieval processing component 1063 and a first phase video signal output component 1064.

The bypass video signal output component 1061 is connected to the main control chip 101, the first sub-frame decoding component 1062 and the display driving assembly 102. The bypass video signal output component 1061 is configured to: receive a video signal; transmit the video signal along two channels; output a video signal in a first channel of the two channels to the first sub-frame decoding component 1062, so that the video signal is decoded, and output a video signal in a second channel of the two channels to the display driving assembly 102, so that the first light modulation device 103 displays an image. Here, the video signal in the first channel is the same as the video signal in the second channel.

It will be noted that there is no need to process the video signal in the second channel. In addition, the bypass video signal output component 1061 may adjust a latency of the video signal in the second channel output by the bypass video signal output component 1061, so that the video signal in the second channel and the phase video signal may be output synchronously.

The first sub-frame decoding component 1062 is connected to the first phase retrieval processing component 1063 and configured to obtain a video signal and decode the video signal to obtain a plurality of video sub-signals.

For example, the first sub-frame decoding component 1062 receives a video signal from the main control chip 101 and obtains a horizontal synchronization signal, a vertical synchronization signal, an enable synchronization signal, R grayscale values, G grayscale values, and B grayscale values of all pixels according to the video signal. Then, the first sub-frame decoding component 1062 generates an R video sub-signal according to the R grayscale values, generates a G video sub-signal according to the G grayscale values, and generates a B video sub-signal according to the B grayscale values. In this case, the first sub-frame decoding component 1062 may be further configured to store the R video sub-signal, the G video sub-signal, and the B video sub-signal in a memory for use in a subsequent phase retrieval algorithm.

It will be noted that a relationship among the video signal, the video sub-signal and the image is as follows: the video signal includes a plurality of images, any one of the images includes an R sub-image, a G sub-image and a B sub-image, a plurality of R sub-images may form an R video sub-signal, a plurality of G sub-images may form a G video sub-signal, and a plurality of B sub-images may form a B video sub-signal.

In some embodiments, the first sub-frame decoding component 1062 is further configured to determine whether to compress a resolution of an image according to a resolution of the second light modulation device 1072. For example, the first sub-frame decoding component 1062 is configured to: obtain a preset resolution of the second light modulation device 1072 and compress an image in the video signal having a resolution greater than the preset resolution, so that a resolution of the compressed image is equal to the preset resolution.

It may be understood that in a case where the number of pixels to which the second light modulation device 1072 may correspond is less than the number of pixels to which the first light modulation device 103 may correspond, the first sub-frame decoding component 1062 compresses a high-resolution image in the video signal to obtain a low-resolution image, so as to match the number of pixels to which the second light modulation device 1072 may correspond. In this way, subsequent components (e.g., the first phase retrieval processing component 1063) may perform the phase retrieval algorithm according to the image after resolution adjustment, so as to obtain phase video information, so that time required for subsequent components to the perform phase retrieval algorithm may be reduced.

The first phase retrieval processing component 1063 is connected to the first phase video signal output component 1064 and configured to obtain a plurality of video sub-signals and determine a phase information signal corresponding to any one of the video sub-signals according to the plurality of video sub-signals. In some examples, the first phase retrieval processing component 1063 obtains the R video sub-signal, the G video sub-signal, and the B video sub-signal, and generates R phase image information corresponding to the R video sub-signal, G phase image information corresponding to the G video sub-signal, and B phase image information corresponding to the B video sub-signal.

For example, the first phase retrieval processing component 1063 reads the R video sub-signal, the G video sub-signal, and the B video sub-signal stored in the memory. Considering the R video sub-signal as an example, the first phase retrieval processing component 1063 performs a plurality of iterative operations according to the phase retrieval algorithm, so as to obtain phase information of pixels in the R video sub-signal, thereby generating R phase image information. Moreover, the first phase retrieval processing component 1063 may cache the generated phase image information to a memory for subsequent output.

It will be noted that computing time of the phase retrieval algorithm performed on the R video sub-signal, the G video sub-signal, and the B video sub-signal by the first phase retrieval processing component 1063 is less than a display duration of each frame of the image.

The first phase video signal output component 1064 is connected to the phase light modulation assembly 107 and configured to generate a phase video signal according to the horizontal synchronization signal, the vertical synchronization signal, and the enable synchronization signal that are obtained through decoding, and combined with R phase image information, G phase image information and B phase image information.

In some embodiments, as shown in FIG. 11, in a case where the main control chip 101 is configured to generate a plurality of video sub-signals according to a video signal and output the plurality of video sub-signals to the video processing assembly 106, there is no need to provide the first sub-frame decoding component 1062 in the video processing assembly 106. Moreover, the main control chip 101 includes a second sub-frame decoding component 1012. The second sub-frame decoding component 1012 is configured to generate a plurality of video sub-signals according to the video signal, and output the plurality of video sub-signals to the video processing assembly 106.

In this case, in the main control chip 101, it is necessary to add a function of decoding the video signal to obtain a plurality of video sub-signals and add an additional video signal output interface for outputting the plurality of video sub-signals, on the basis of decoding the video signal by the main control chip 101.

For example, when the main control chip 101 decodes the external video source to obtain the video signal, the main control chip 101 also obtains the video sub-signals. In this process, the main control chip 101 may also compress the image included in the video signal according to the resolution of the second light modulation device 1072, so as to generate the video sub-signals. Moreover, the main control chip 101 may output a plurality of video sub-signals through a transistor-transistor logic (TTL) interface, so as to simplify decoding requirements of the video processing assembly 106.

As shown in FIG. 11, the main control chip 101 further includes a video decoding component 1011. The video decoding component 1011 may decode the external video source and output the video signal along different channels. The function of the video decoding component 1011 is similar to that of the bypass video signal output component 1061 in FIG. 10, and details will not be repeated herein.

It is also necessary to adjust a latency of the video signal transmitted from the main control chip 101 to the display driving assembly 102, so as to meet the computing time requirement. Moreover, the plurality of video sub-signals are required to have the same phase difference and frame synchronization with the video signal output to the display driving assembly 102, so that the video signal output to the display driving assembly 102 and the phase video signal may be output synchronously.

Corresponding to the structure of the main control chip 101, as shown in FIG. 11, the video processing assembly 106 includes a second phase retrieval processing component 1065 and a second phase video signal output component 1066. Since there is no need for the video processing assembly 106 to decode the video signal to obtain the plurality of video sub-signals, the video processing assembly 106 only needs to receive the plurality of video sub-signals.

The second phase retrieval processing component 1065 is connected to the second sub-frame decoding component 1012 and the second phase video signal output component 1066, and the function of the second phase retrieval processing component 1065 is similar to that of the first phase retrieval processing component 1063, and details will not be repeated herein.

The second phase video signal output component 1066 is connected to the phase light modulation assembly 107, and the function of the second phase video signal output component 1066 is similar to that of the first phase video signal output component 1064, and details will not be repeated herein.

It may be understood that in a case where the main control chip 101 is configured to generate a plurality of video sub-signals according to the video signal and output the plurality of video sub-signals to the video processing assembly 106, the video processing assembly 106 may receive the plurality of video sub-signals and the video signal to be input into the display driving assembly 102, and adjust the latency of the video signal, so that the phase video signal output by the video processing assembly 106 may be synchronized with the video signal output by the video processing assembly 106 to the display driving assembly 102. In this way, the timings may be adjusted by a same chip (e.g., the chip in the video processing assembly 106), so that the circuit structure may be simplified.

Two manners in which the video processing assembly 106 determines the phase video signal are described below.

In some embodiments, the video processing assembly 106 is configured to: obtain luminance information of a plurality of sub-images in any one of video sub-signals after obtaining a plurality of video sub-signals, and generate phase image information corresponding to the video sub-signal according to luminance information of the plurality of sub-images; and generate a phase video signal according to phase image information corresponding to the plurality of video sub-signals. Here, the luminance information may be a luminance value of a sub-image.

In some embodiments, the video processing assembly 106 is configured to: obtain luminance compensation parameters and luminance information of a plurality of sub-images in any one of the video sub-signals after obtaining a plurality of video sub-signals, and generate phase image information corresponding to the video sub-signal according to luminance information of the plurality of sub-images and the luminance compensation parameters; and generate a phase video signal according to phase image information corresponding to the plurality of video sub-signals.

The luminance compensation parameters include first luminance correction parameters corresponding to laser beams of a plurality of primary colors, such as first luminance correction parameters corresponding to R, first luminance correction parameters corresponding to G, and first luminance correction parameters corresponding to B. Considering R as an example, the first luminance correction parameters corresponding to red laser beams may be as shown in FIG. 12. In FIG. 12, an image is divided into 3×3 image regions, and each number represents a luminance compensation parameter of an image region.

For example, for any sub-image in the R video sub-signal, as shown in FIG. 12, the video processing assembly 106 divides the sub-image into 3×3 image regions, and then calculates luminance information of each image region. The number in each image region in the figure represents a luminance value. In some embodiments, luminance information of a center point of an image region may be obtained, and the luminance information of the center point may represent luminance information of the image region. The center point may be a center pixel of an image region, and the number of the center pixels may be one or more, and the present disclosure is not limited thereto.

The video processing assembly 106 may obtain a luminance compensation parameter of the corresponding region to adjust the luminance of the corresponding image region after obtaining luminance information of the image regions. For example, the video processing assembly 106 multiplies luminance information of a first image region by the luminance compensation parameter (e.g., 0.9) corresponding to the first image region (i.e., the image region in the upper left corner in FIG. 12) in FIG. 12. In this way, luminance of the image region with low luminance may be reduced, and luminance of the image region with high luminance may be increased, so that some laser beams in the central region of an image may be transferred to the edges of the image, so that light intensity distribution of the illumination beams may be adjusted, and the luminance compensation may be performed on the dark regions in the image, thereby improving the luminance uniformity of the displayed image.

The luminance compensation operation is described by considering the video processing assembly 106 in FIG. 10 as an example.

The first sub-frame decoding component 1062 is configured to obtain a video signal and decode the video signal to obtain a plurality of video sub-signals.

The first phase retrieval processing component 1063 is configured to: obtain luminance compensation parameters and luminance information of a plurality of sub-images in any one of the video sub-signals, and generate a phase information signal corresponding to the video sub-signal according to luminance information of the plurality of sub-images and luminance compensation parameters. As a result, the first phase video signal output component 1064 may generate the phase video signal according to the phase information signals corresponding to the plurality of video sub-signals. It may be understood that the first phase retrieval processing component 1063 may also perform the operations of the first phase video signal output component 1064.

How to obtain the luminance compensation parameters is described below.

In some embodiments, the video processing assembly 106 is further configured to: obtain luminance information of the captured images corresponding to a plurality of color cards, and determine luminance compensation parameters according to the luminance information of the captured images corresponding to the plurality of color cards. Moreover, the video processing assembly 106 may be further configured to store the luminance compensation parameters for use in generating the phase video signal.

For example, the video processing assembly 106 receives the captured images sent by a luminance measuring device. The luminance measuring device may be a device with a shooting function, or a device such as a luminance meter, and the present disclosure is not limited thereto.

In some embodiments, the video processing assembly 106 is further configured to: divide the captured image corresponding to any color card into a plurality of image regions, and obtain luminance information of any image region; determine luminance compensation parameters corresponding to the plurality of image regions according to luminance information of the plurality of image regions; and determine the first luminance correction parameters corresponding to any color card according to the luminance compensation parameters corresponding to the plurality of image regions.

In some embodiments, the video processing assembly 106 is further configured to: obtain a target matrix; and determine a luminance compensation parameter of any image region according to luminance information of any image region and a value of an element corresponding to the image region in the target matrix. Here, the number of elements in the target matrix is the same as the number of the plurality of image regions, and the elements in the target matrix correspond to the plurality of image regions, respectively.

For example, the video processing assembly 106 divides the value of any element in the target matrix by luminance information of the corresponding image region, thereby obtaining the luminance compensation parameter corresponding to the image region.

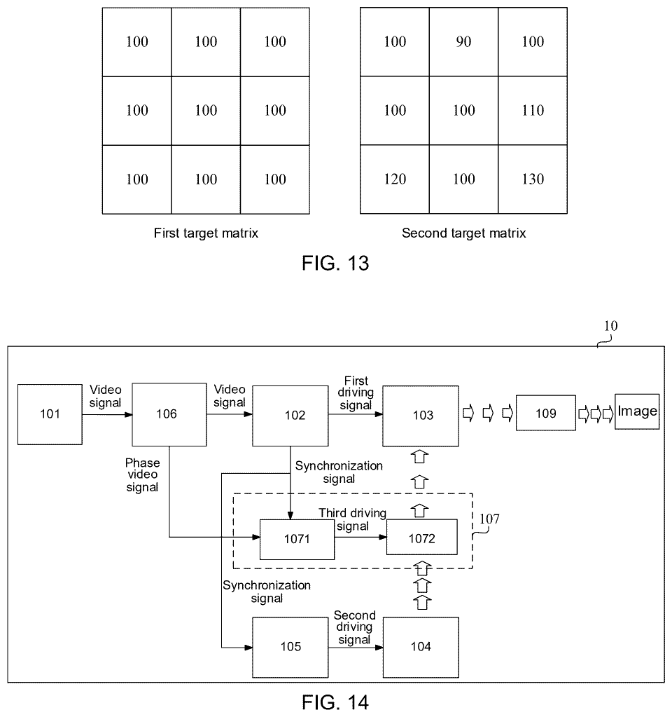

In some embodiments, the target matrix includes same elements, and values of the elements may be equal to an average of luminance information of the plurality of image regions. That is to say, the target matrix may be determined according to the average of luminance information of the plurality of image regions. For example, as shown in FIG. 13, in a case where an image is divided into 3×3 image regions and an average of luminance information of the plurality of image regions is equal to 100, the target matrix is a matrix (i.e., a first target matrix) with three rows and three columns, and each element in the matrix may be equal to 100. In this way, luminance of the image may be evenly distributed.

In some embodiments, the target matrix may further include a plurality of different elements, and the plurality of different elements correspond to image regions with different luminance information, respectively. The element corresponding to the image region with low luminance may be different from the element corresponding to the image region with high luminance, so that local luminance adjustment may be achieved. For example, as shown in FIG. 13, the target matrix is a second target matrix.

For example, the laser projection apparatus 10 projects a color card on a screen, and the luminance measuring device may capture the color card to obtain a captured image. Then, the video processing assembly 106 may divide the captured image into a plurality of image regions. For example, the video processing assembly 106 divides the captured image into nine image regions, sixteen image regions, or more image regions. The more the image regions, the more precise the adjustment of the luminance uniformity of the image. It may be understood that the color cards in some embodiments of the present disclosure are solid color cards. For example, the color card corresponding to red is a solid red color card.

It may be understood that a set of first luminance correction parameters may be obtained according to the red color card, a set of first luminance correction parameters may be obtained according to the green color card, and a set of first luminance correction parameters may be obtained according to the blue color card. The luminance compensation parameters include a plurality of first luminance correction parameters corresponding to a plurality of color cards.

In some embodiments, the video processing assembly 106 is further configured to: correct the luminance compensation parameters to obtain corrected luminance compensation parameters after obtaining luminance compensation parameters. For example, the video processing assembly 106 corrects the first luminance correction parameters corresponding to red, the first luminance correction parameters corresponding to green, and the first luminance correction parameters corresponding to blue.

For example, the video processing assembly 106 is further configured to: determine whether the first luminance correction parameters corresponding to any color card meet a preset condition; if not, correct the first luminance correction parameters corresponding to the color card until the corrected first luminance correction parameters meet the preset condition, and select the corrected first luminance correction parameters as second luminance correction parameters; if so, select the first luminance correction parameters corresponding to the color card as the second luminance correction parameters.

The preset condition is that the captured image on which luminance correction is performed according to the first luminance correction parameters has uniformly distributed luminance. Moreover, the second luminance correction parameters meet the preset condition, and the luminance compensation parameters include second luminance correction parameters corresponding to a plurality of color cards.

Considering the first luminance correction parameters corresponding to red as an example, the video processing assembly 106 divides the corrected captured image into a plurality of image regions and determines luminance information of image regions after correcting luminance of the captured image corresponding to the red card according to the first luminance correction parameters. Then, the video processing assembly 106 calculates a difference in luminance between any two image regions. If the difference is less than a preset threshold, the video processing assembly 106 may determine that the captured image on which luminance correction is performed has uniformly distributed luminance. That is to say, the video processing assembly 106 determines that the first luminance correction parameters corresponding to the color card meet the preset condition.

In some embodiments, the video processing assembly 106 is further configured to: divide the captured image corresponding to any color card into a plurality of image regions and obtain luminance information of any image region in a case where the first luminance correction parameters corresponding to any color card cannot meet the preset condition; determine the luminance compensation parameters corresponding to the plurality of image regions according to luminance information corresponding to the plurality of image regions; and determine the corrected first luminance correction parameters (i.e., the second luminance correction parameters) corresponding to the color card according to the luminance compensation parameters corresponding to the plurality of image regions.

Here, the number of the plurality of image regions divided by the video processing assembly 106 during correction is greater than the number of the plurality of image regions divided by the video processing assembly 106 before correction.

For example, when generating the first luminance correction parameters, the video processing assembly 106 divides the captured image corresponding to the color card into nine image regions. In this case, when correcting the first luminance correction parameters, the video processing assembly 106 may divide the captured image corresponding to the color card into sixteen image regions, and obtain luminance information of any image region. Then, the video processing assembly 106 determines luminance compensation parameters corresponding to the image regions according to the luminance information, and determines the corrected first luminance correction parameters according to the luminance compensation parameters corresponding to the plurality of image regions.

In some embodiments of the present disclosure, the video processing assembly 106 may determine first luminance correction parameters corresponding to different colors according to the captured images corresponding to the color cards of three colors. In this way, the video processing assembly 106 may use the first luminance correction parameters corresponding to R to perform luminance compensation on the R sub-image in the R video sub-signal after the video signal is divided into the R video sub-signal, the G video sub-signal and the B video sub-signal. Afterwards, the video processing assembly 106 may generate phase image information corresponding to R according to the R sub-image on which luminance compensation is performed, so as to perform local adjustment on luminance, thereby improving the luminance uniformity of the displayed image.

How the phase light modulation assembly 107 performs phase modulation is described below.

In some embodiments, as shown in FIG. 14, the phase light modulation assembly 107 includes a light modulation driving group 1071 and a second light modulation device 1072.

The light modulation driving group 1071 is connected to the video processing assembly 106, the display driving assembly 102 and the second light modulation device 1072, and configured to send a third driving signal to the second light modulation device 1072 according to the phase video signal and the synchronization signal.

The second light modulation device 1072 is configured to perform phase modulation according to the third driving signal and output first modulated beams to the first light modulation device 103, so that the first light modulation device 103 perform light modulation according to the first modulated beams, thereby achieving image display.

In a case where light waves propagate a same distance in a medium, the phase change is related to the wavelength of the light wave. Therefore, light waves of different colors correspond to different phase changes. The signal input to the light modulation driving group 1071 is the phase video signal, and the phase video signal includes multiple phase image information (i.e., images after Fourier transformation). A maximum displacement that a mirror 1073 of the light phase modulator can move corresponds to the phase change. The maximum displacement of the mirror 1073 of the light phase modulator may be determined according to a bias voltage. Therefore, three light waves (e.g., red laser beams, green laser beams, and blue laser beams) having different wavelengths correspond to different bias voltages. Moreover, for light waves having different wavelengths, different bias voltages may be used to make the mirror 1073 perform different displacements, thereby achieving phase modulation of the light waves.

In some embodiments, the light modulation driving group 1071 is further configured to: obtain a bias voltage of the second light modulation device 1072 according to the enable signal; and send a third driving signal to the second light modulation device 1072 according to the enable signal, the PWM signal and the phase video signal. The third driving signal includes the bias voltage.

In this case, the second light modulation device 1072 is further configured to control displacement of the mirrors 1073 of the second light modulation device 1072 according to the bias voltage, so as to perform phase modulation on the primary color laser beams through the displaced mirrors 1073, so that precise adjustment of the phases of the primary color laser beams with different wavelengths may be achieved.

The bias voltage includes bias sub-voltages corresponding to primary color laser beams with different wavelengths. For example, the bias voltage includes a bias sub-voltage corresponding to red laser beams, a bias sub-voltage corresponding to green laser beams, and a bias sub-voltage corresponding to blue laser beams.

It may be understood that, considering red laser beams as an example, since the second timing is synchronized with the third timing, when the laser source assembly 104 emits red laser beams, the second light modulation device 1072 may control displacement of the mirrors 1073 according to the bias sub-voltage corresponding to the red laser beams, so that the displaced mirrors 1073 may perform phase modulation on the red laser beams emitted by the laser source assembly 104.

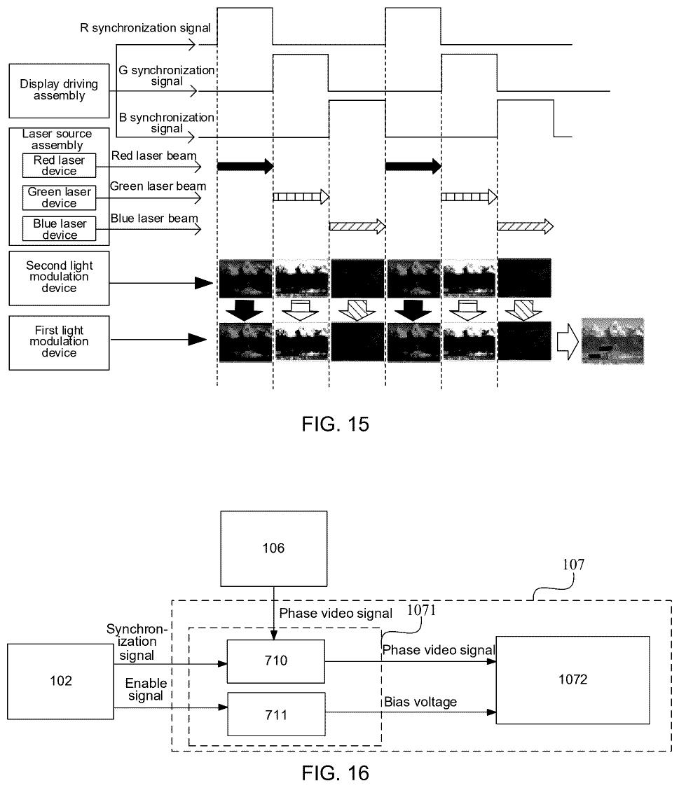

In this case, the first light modulation device 103 refreshes the micromirrors 1032 corresponding to the red laser beams on the first light modulation device 103, and receives the first modulated beams corresponding to the red laser beams through the refreshed micromirrors 1032, so as to display an image. FIG. 15 shows a synchronization relationship among the laser source assembly 104, the second light modulation device 1072, and the first light modulation device 103.

In some embodiments, a moment when the second light modulation device 1072 receives the third driving signal is the same as a moment when the first light modulation device 103 receives the first driving signal. That is to say, a moment when the second light modulation device 1072 receives a phase modulation instruction is synchronized with a moment when the first light modulation device 103 receives a display modulation instruction. For example, a latency of a driving component with a faster transmission speed between the corresponding driving components of the two (i.e., the second light modulation device 1072 and the first light modulation device 103) is adjusted to meet the transmission time requirement of the driving component with a slower transmission speed between the corresponding driving components of the two, so that the second light modulation device 1072 and the first light modulation device 103 may receive the corresponding driving signals at the same time.

In some embodiments, it may be necessary to add additional image processing operations, so as to add image correction functions such as keystone correction of projection, screen alignment of projection or obstacle avoidance of projection in the display driving assembly 102. For example, after a frame of image is cached, it is necessary to move the corresponding pixels through the image correction algorithm and recalculate the grayscale of the image, so as to achieve the image correction function. Therefore, it is possible to increase the latency of the third driving signal sent by the light modulation driving group 1071 to the second light modulation device 1072, so that the third driving signal is synchronized with the first driving signal output by the display driving assembly 102.

Here, the keystone correction may be understood as adjusting a shape of the projection image physically or by software to avoid the projection image in a shape of a trapezoid. The screen alignment may be understood as adjusting the projection image so that the projection image may be displayed completely on a screen or wall and does not exceed the edge of the screen or wall. The obstacle avoidance may be understood as automatically adjusting the projection angle and image luminance to avoid damage to the device itself and the surrounding environment when obstacles appear.

The synchronization relationship among the laser source assembly 104, the second light modulation device 1072, and the first light modulation device 103 is described below by considering the red laser beams as an example.

The first light modulation device 103 and the second light modulation device 1072 complete receiving red image data before the laser driving assembly 105 and the light modulation driving group 1071 receive the synchronization signal.

When the laser driving assembly 105 and the light modulation driving group 1071 receive the synchronization signal, the following operations are performed synchronously.

The laser driving assembly 105 drives the red laser device in the laser source assembly 104 to be turned on, so as to emit red laser beams to the second light modulation device 1072. In this case, the laser devices emitting laser beams of other colors are turned off.

The light modulation driving group 1071 sends the third driving signal corresponding to the red laser beams to the second light modulation device 1072. For example, the light modulation driving group 1071 sends a bias sub-voltage corresponding to the red laser beams to the second light modulation device 1072. At this time, a minimum unit of displacement of the mirrors 1073 of the second light modulation device 1072 meets the wavelength requirement of the red laser beams. The second light modulation device 1072 receives the third driving signal sent by the light modulation driving group 1071 and shifts the mirrors 1073 according to the bias sub-voltage, so as to achieve phase modulation of the red laser beams, thereby achieving low-resolution adjustment. Here, since the resolution of the second light modulation device 1072 is less than the resolution of the first light modulation device 103, the phase modulation of the second light modulation device 1072 may be referred to as low-resolution adjustment.

The first light modulation device 103 receives the first driving signal sent by the display driving assembly 102. The first light modulation device 103 refreshes the states of the micromirrors 1032 of the first light modulation device 103 after receiving the first driving signal. The first light modulation device 103 adjusts swing time of the micromirrors 1032 to make the plurality of micromirrors 1032 swing simultaneously according to the determined states, so as to perform PWM modulation on the first modulated beams output by the second light modulation device 1072, so that high-resolution display is achieved and image display is completed.

The synchronization relationships corresponding to other primary color laser beams are the same as that of the red laser beams, which may refer to the relevant content of the red laser beams, and details will not be repeated herein.

In some embodiments, as shown in FIG. 16, the light modulation driving group 1071 includes a light modulation driving component 710 and a bias voltage conversion circuit 711.

The light modulation driving component 710 is connected to the video processing assembly 106, the display driving assembly 102 and the second light modulation device 1072, and is configured to: receive the phase video signal sent by the video processing assembly 106 and the synchronization signal sent by the display driving assembly 102; send the phase video signal to the second light modulation device 1072 according to the synchronization signal, so as to drive the mirrors 1073 of the second light modulation device 1072 to move, so that phase modulation is achieved.

The bias voltage conversion circuit 711 is connected to the display driving assembly 102 and the second light modulation device 1072, and is configured to receive the enable signal sent by the display driving assembly 102 and send a bias voltage to the second light modulation device 1072 according to the enable signal.

It may be understood that the phase video signal is composed of continuous phase image information (also referred to as a hologram). Therefore, the light modulation driving component 710 may, according to a cycle order of the multiple primary color laser beams corresponding to the third timing, drive the second light modulation device 1072 to perform phase modulation according to the corresponding phase image information and the bias voltage. It will be noted that phase image information in some embodiments of the present disclosure may be hologram information, so as to correspond to hologram display.

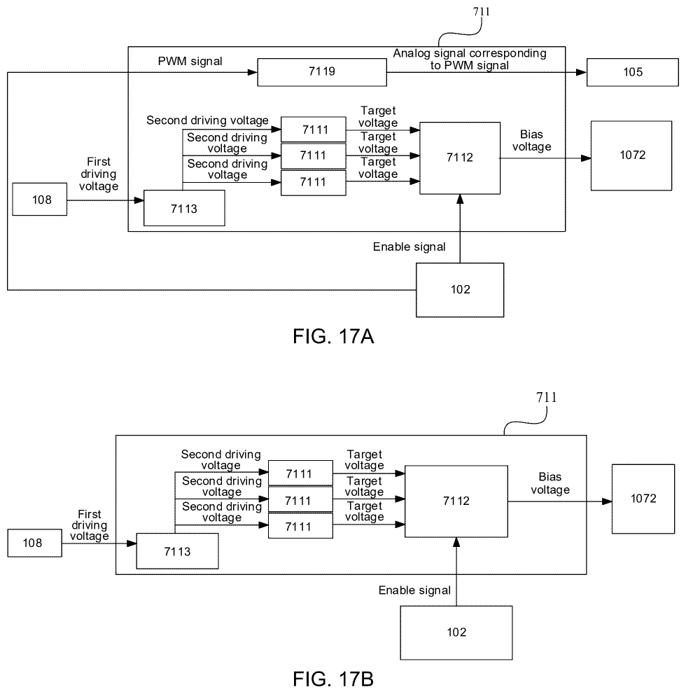

In some embodiments, as shown in FIG. 17A, the bias voltage conversion circuit 711 is connected to the display driving assembly 102, the laser driving assembly 105, and the second light modulation device 1072. The bias voltage conversion circuit 711 is configured to: receive the enable signal and PWM signal sent by the display driving assembly 102; send a bias voltage to the second light modulation device 1072 according to the enable signal; and perform digital-to-analog conversion on the PWM signal and send the analog signal corresponding to the PWM signal to the laser driving assembly 105.

For example, as shown in FIG. 17A, the bias voltage conversion circuit 711 includes a first DAC 7119. The first DAC 7119 is connected to the display driving assembly 102 and the laser driving assembly 105, and is configured to: receive the PWM signal sent by the display driving assembly 102 and perform digital-to-analog conversion on the PWM signal, and send the analog signal corresponding to the PWM signal to the laser driving assembly 105.

In this way, the display driving assembly 102 may determine the PWM signal according to the video signal, and the first DAC 7119 in the bias voltage conversion circuit 711 performs digital-to-analog conversion on the PWM signal, so that the analog signal corresponding to the PWM signal is obtained. Then, the analog signal is sent to the laser driving assembly 105, so that the laser driving assembly 105 generates the second driving signal according to the analog signal and the enable signal. Here, the enable signal may be an enable signal sent by the display driving assembly 102 in a case where the laser driving assembly 105 is connected to the display driving assembly 102; alternatively the enable signal may be an enable signal sent by the display driving assembly 102 and received by the light modulation driving group.

In some embodiments, as shown in FIGS. 17A and 17B, the bias voltage conversion circuit 711 includes: a plurality of voltage regulators 7111 and an analog switch 7112.

The plurality of voltage regulators 7111 are configured to send target voltages corresponding to the laser beams of the plurality of primary colors to the analog switch 7112. For example, in an example where the plurality of voltage regulators 7111 include three voltage regulators 7111, the three voltage regulators 7111 send target voltages corresponding to red laser beams, green laser beams, and blue laser beams to the analog switch 7112, and the plurality of voltage regulators 7111 correspond to different target voltages.

The analog switch 7112 is connected to the plurality of voltage regulators 7111, the display driving assembly 102, and the second light modulation device 1072. The analog switch 7112 is configured to: receive the enable signal sent by the display driving assembly 102, obtain a bias voltage from the target voltages corresponding to the laser beams of the plurality of primary colors according to the enable signal, and send the bias voltage to the second light modulation device 1072.

For example, in a case where the third timing is an R-G-B cycle, if it is determined that the timing cycles to the red laser beam according to the enable signal, the analog switch 7112 may obtain the target voltage corresponding to the red laser beam from the target voltages corresponding to the red laser beam, the green laser beam, and the blue laser beam, and use the target voltage as the bias voltage.

The analog switch 7112 may output different bias voltages to switch the bias voltages according to the third timing after the target voltages corresponding to the laser beams of three primary colors are input to the analog switch 7112 through the three voltage regulators 7111. That is to say, when laser beams of a primary color are incident on the second light modulation device 1072, the analog switch 7112 may switch the bias voltage to a corresponding voltage value, so as to shift the mirrors 1073 of the second light modulation device 1072, so that phase modulation is achieved.

In some embodiments, as shown in FIGS. 17A and 17B, the laser projection apparatus 10 further includes a power supply 108. In this case, the bias voltage conversion circuit 711 further includes a direct current-direct current (DC/DC) converter 7113.

The DC/DC converter 7113 is connected to the power supply 108 and the plurality of voltage regulators 7111, and is configured to input a second driving voltage to the plurality of voltage regulators 7111 according to a first driving voltage input by the power supply 108. In this case, any one of the voltage regulators 7111 may be configured to input a target voltage corresponding to the voltage regulator 7111 to the analog switch 7112 according to the second driving voltage.

For example, the power supply 108 may generate a first driving voltage of 12V to drive the bias voltage conversion circuit 711 to operate. The first driving voltage of 12V is converted into a second driving voltage of 5V after passing through the DC/DC converter, and the second driving voltage of 5V is input into the three voltage regulators 7111. In this case, different target voltages may be generated by changing resistance values of voltage division resistances in the three voltage regulators 7111, so that the analog switch 7112 may switch between different bias voltages and output corresponding bias voltage.

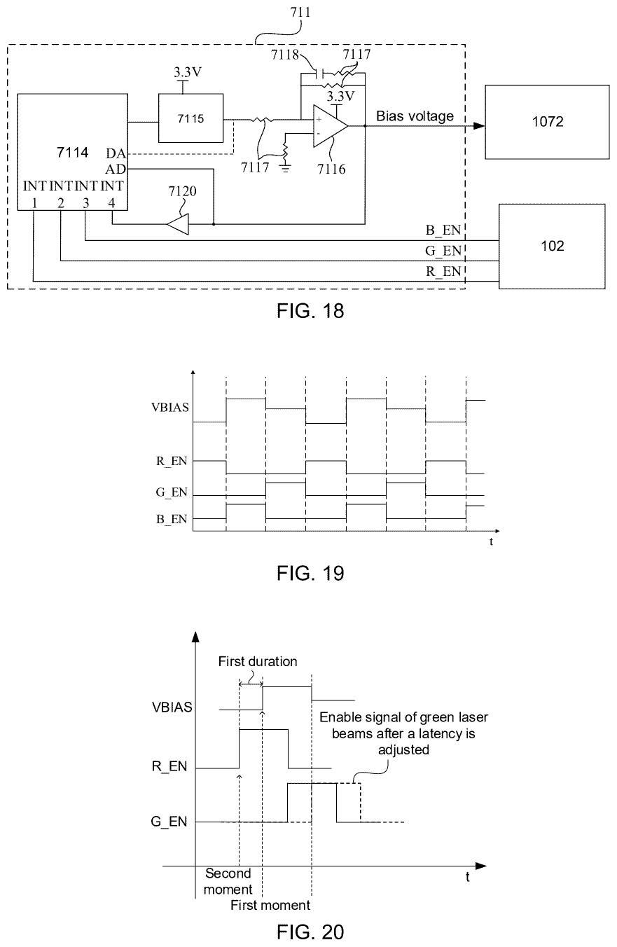

Of course, the bias voltage conversion circuit 711 is not limited to the structure described above. In some embodiments, as shown in FIG. 18, the bias voltage conversion circuit 711 includes a control assembly 7114, a second DAC 7115, and an amplifier 7116.

The control assembly 7114 is connected to the display driving assembly 102 and the second DAC 7115, and is configured to receive an enable signal sent by the display driving assembly 102 and input target voltages corresponding to the primary color laser beams to the second DAC 7115 according to the enable signal.

Here, the control assembly 7114 and the second DAC 7115 may be connected by an inter-integrated circuit (I2C) bus or a serial peripheral interface (SPI) bus. SPI bus connection may improve communication efficiency. The present disclosure does not limit the connection manner between the control assembly 7114 and the second DAC 7115.

The second DAC 7115 is configured to convert a target voltage into a voltage analog signal.

The amplifier 7116 is connected to the second DAC 7115 and the second light modulation device 1072, and is configured to send a bias voltage to the second light modulation device 1072 according to the voltage analog signal. Moreover, the amplifier 7116 may adjust a range of the voltage. For example, in a case where the target voltage is low, an amplification factor of the amplifier 7116 is less than 1, so as to improve the control accuracy.

For example, as shown in FIG. 18, the bias voltage conversion circuit 711 further includes four resistances 7117 and one capacitor 7118. A first end of the first resistance 7117 is connected to the second DAC 7115, and a second end of the first resistance 7117 is connected to a first end (e.g., a non-inverting input end) of the amplifier 7116. A first end of the second resistance 7117 is grounded, and a second end of the second resistance 7117 is connected to a second end (e.g., an inverting input end) of the amplifier 7116. A first end of the third resistance 7117 is connected to the first end of the amplifier 7116, and a second end of the third resistance 7117 is connected to a third end (e.g., an output end) of the amplifier 7116. A first end of the fourth resistance 7117 is connected to a first end of the capacitor 7118, and a second end of the fourth resistance 7117 is connected to the third end of the amplifier 7116. A second end of the capacitor 7118 is connected to the first end of the amplifier 7116.

In some embodiments, the second DAC 7115 may be integrated into the control assembly 7114, so that the control assembly 7114 may have a digital-to-analog conversion function. In this case, the control assembly 7114 is connected to the amplifier 7116 and is also configured to perform digital-to-analog conversion on the target voltage to obtain a voltage analog signal, and send the voltage analog signal to the amplifier 7116 through a digital-to-analog (DA) interface, so that the amplifier 7116 sends a bias voltage to the second light modulation device 1072 according to the voltage analog signal. It will be noted that the dashed line in FIG. 18 shows that the control assembly 7114 sends a voltage analog signal to the amplifier 7116 through the DA interface.

In some embodiments, the control assembly 7114 may be a microcontroller unit (MCU).

For example, the control assembly 7114 receives the enable signal R_EN corresponding to the red laser beams, the enable signal G_EN corresponding to the green laser beams, and the enable signal B_EN corresponding to the blue laser beams through interrupt ports INT1, INT2, and INT3, and outputs three different target voltages according to the three enable signals, so as to input the corresponding voltage analog signal to the amplifier 7116.

Since an error is prone to occur in the target voltage after the target voltage is converted by the second DAC 7115 and amplified by the amplifier 7116, the following voltage correction operation may be performed.

In some embodiments, as shown in FIG. 18, the amplifier 7116 is further connected to the control assembly 7114 and is further configured to send a bias voltage to the control assembly 7114. In this case, the control assembly 7114 is further configured to perform voltage correction on the target voltages corresponding to the subsequent primary color laser beams according to the bias voltage. Here, the subsequent primary color laser beams may be understood as the primary color laser beams subsequent to the current primary color laser beams.

In some examples, the third end of the amplifier 7116 is connected to an analog-to-digital (AD) interface of the control assembly 7114, so as to input the bias voltage into the control assembly 7114 through the AD interface. The control assembly 7114 may calculate a difference between a voltage value received by the AD interface and a voltage value of the bias voltage required for the current primary color laser beams according to the voltage value received by the AD interface. Then, the control assembly 7114 performs voltage correction on the target voltages corresponding to the subsequent primary color laser beams according to the difference.

For example, in a case where the voltage value of the bias voltage required for the current primary color laser beams is 1.15V and the voltage value received by the control assembly 7114 through the AD interface is 1.14V, the control assembly 7114 may determine that a voltage difference is 0.01V. In this case, the control assembly 7114 may increase the target voltages corresponding to the subsequent primary color laser beams by 0.01V. For example, if the bias voltage required for the subsequent primary color laser beams is 1.18V (e.g., the target voltage of the primary color laser beams is 1.18V), the control assembly 7114 may increase the target voltage corresponding to the primary color laser beams by 0.01V. That is to say, the control assembly 7114 outputs a target voltage corresponding to the voltage value of 1.19V to compensate for the voltage value of 0.01V lost due to the conversion of the second DAC 7115 and the amplification of the amplifier 7116, thereby ensuring that the bias voltage input to the second light modulation device 1072 is the required voltage value of 1.18V.

In this way, the error in the target voltage due to the conversion of the second DAC 7115 and the amplification of the amplifier 7116 may be determined according to the difference between the voltage value output by the amplifier 7116 and the target voltage. As a result, the bias voltage of the subsequent primary color laser beams may be corrected according to the error, so that closed-loop control may be achieved and the accuracy of the bias voltage input to the second light modulation device 1072 may be improved.

FIG. 19 is a waveform diagram in a case of no latency. In FIG. 19, the reference sign “VBIAS” represents the bias voltage.

The voltage value of the target voltage requires a certain amount of time for digital-to-analog conversion and amplification by the amplifier 7116 after the control assembly 7114 receives the enable signal. Therefore, in order to synchronize the enable signal output by the display driving assembly 102 to the laser driving assembly 105 with the bias voltage output by the amplifier 7116, an output latency of the enable signal corresponding to the subsequent primary color laser beams may be adjusted in the following manner.

In some embodiments, the control assembly 7114 is further configured to: obtain a first moment when the amplifier 7116 outputs a bias voltage corresponding to the current primary color laser beams, and a second moment when the display driving assembly 102 outputs an enable signal corresponding to the current primary color laser beams; obtain a preset duration according to the first moment and the second moment; and delay output time of the enable signal corresponding to the subsequent primary color laser beams by the preset duration, so that the enable signal may be synchronized with the bias voltage.

For example, as shown in FIG. 18, the control assembly 7114 receives an input/output (I/O) level signal obtained by the voltage conversion and the conversion by the Schmitt trigger 7120 through an interrupt port INT4. Since the I/O level signal is generated according to the bias voltage output by the amplifier 7116, the control assembly 7114 may obtain the first moment according to the I/O level signal.

How to adjust output time of the enable signal corresponding to the subsequent primary color laser beams is described by considering an example in which the current primary color laser beams are red laser beams and the subsequent primary color laser beams are green laser beams. FIG. 20 shows the adjusted timing of the enable signal corresponding to the subsequent primary color laser beams in a case of a latency. As shown in FIG. 20, the enable signal of the green laser beams after the latency is adjusted is delayed by a first duration.

The bias voltage may control positions (e.g., heights) of mirrors 1073 of the second light modulation device 1072, and different wavelengths of coherent light waves correspond to different bias voltages. Moreover, a slight voltage change within a determined bias voltage range may make a slight height change of the mirror 1073, thereby causing a change in the position of the coherent speckle, thereby forming speckle.

Therefore, in order to reduce speckle, in some embodiments, the amplifier 7116 may further be configured to adjust the bias voltage according to a preset voltage signal to obtain a processed bias voltage, and send the processed bias voltage to the second light modulation device 1072. Here, the preset voltage signal is configured to control the bias voltage to vary within a target voltage range. It may be understood that the bias voltage is transmitted to the second light modulation device 1072 in the form of a continuous signal, and the bias voltage received by the second light modulation device 1072 may be referred to as a bias voltage signal.

In this case, the control assembly 7114 is further configured to output the preset voltage signal to the amplifier 7116. The amplifier 7116 superimposes the preset voltage signal and the bias voltage signal to obtain the processed bias voltage signal.

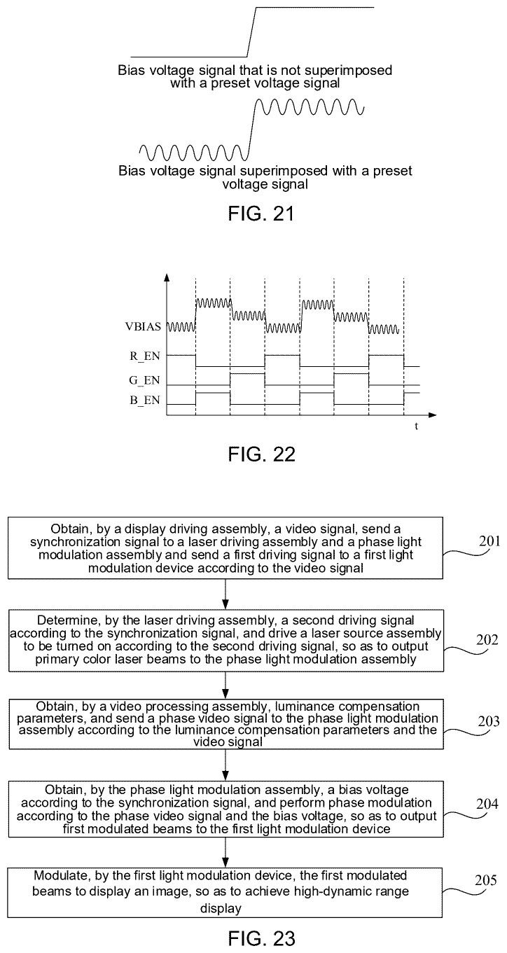

For example, as shown in FIG. 21, the amplifier 7116 superimposes the preset voltage signal and the bias voltage signal, and inputs the processed bias voltage signal into the second light modulation device 1072, so as to drive the mirrors of the second light modulation device 1072 to vibrate slightly. In this way, the speckle in the corresponding diffraction image may move quickly, so as to reduce the speckle contrast through time integral, so that the speckle may be reduced.

FIG. 22 shows waveforms of a plurality of enable signals and a bias voltage superimposed with a speckle elimination waveform (i.e., the preset voltage signal).

In some embodiments, the display driving assembly 102 is further configured to send a control signal to the control assembly 7114. The control signal may be configured to control an operating mode of the control assembly 7114. For example, the control signal controls whether the control assembly 7114 outputs the preset voltage signal. Alternatively, the control signal may specify that the control assembly 7114 performs speckle elimination processing on one or more of the laser beams of three primary colors, as well as the amplitude and frequency of the speckle elimination waveform.

An image display method of a laser projection apparatus is further provided in some embodiments of the present disclosure. The method is applied to a laser projection apparatus. For the structure of the laser projection apparatus, reference may be made to the laser projection apparatus 10 in the embodiments described above, and details will not be repeated herein. As shown in FIG. 23, the method includes step 201 to step 205.

In step 201, a display driving assembly obtains a video signal, sends a synchronization signal to a laser driving assembly and a phase light modulation assembly and sends a first driving signal to a first light modulation device according to the video signal.

In step 202, the laser driving assembly determines a second driving signal according to the synchronization signal, and drives the laser source assembly to be turned on according to the second driving signal, so as to output primary color laser beams to the phase light modulation assembly.

In step 203, a video processing assembly obtains luminance compensation parameters, and sends a phase video signal to the phase light modulation assembly according to the luminance compensation parameters and the video signal.

In step 204, the phase light modulation assembly obtains a bias voltage according to the synchronization signal, and performs phase modulation according to the phase video signal and the bias voltage, so as to output first modulated beams to the first light modulation device.

In step 205, the first light modulation device modulates the first modulated beams to display an image, so as to achieve HDR display. For example, the first light modulation device modulates the first modulated beams according to the first driving signal, so as to achieve HDR display.

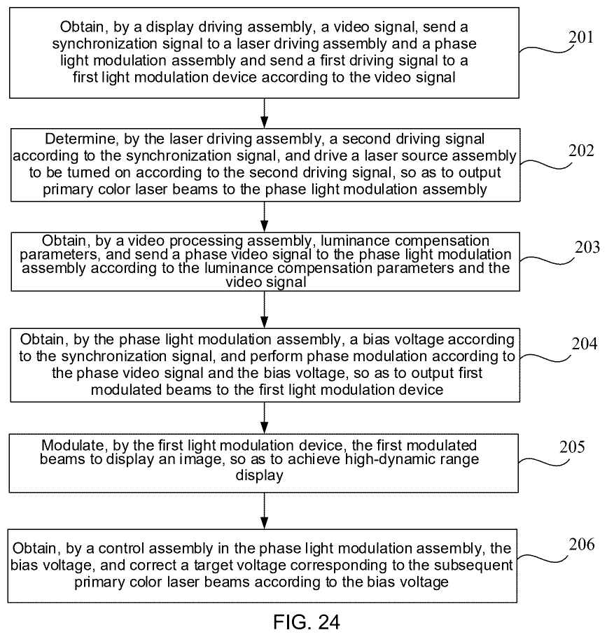

In some embodiments, as shown in FIG. 24, the method further includes step 206.

In step 206, a control assembly in the phase light modulation assembly obtains the bias voltage, and corrects a target voltage corresponding to the subsequent primary color laser beams according to the bias voltage. The bias voltage corresponding to the subsequent primary color laser beams may be determined according to the corrected target voltage.

The implementation principle and technical effect of the image display method of the laser projection apparatus provided in some embodiments of the present disclosure are similar to those of the laser projection apparatus 10 described above, and details will not be repeated herein.

It will be noted that the steps described in a specific order in the drawings of some embodiments of the present disclosure do not require or imply that these steps must be performed in such specific order or that all the steps shown must be performed to achieve the desired results. Each step in the drawings may be appended, some steps may be omitted, multiple steps may be combined into one step for execution, or one step may be decomposed into multiple steps for execution, etc.

Some embodiments of the present disclosure provide a computer-readable storage medium (e.g., a non-transitory computer-readable storage medium) having stored computer program instructions that, when executed by a processor, make the processor to execute one or more steps of the image display method of the laser projection apparatus as described in any of the above embodiments.

For example, the computer-readable storage medium may include, but is not limited to: a magnetic storage device (e.g., a hard disk, a floppy disk, or a magnetic tape), an optical disk (e.g., a compact disk (CD), a digital versatile disk (DVD)), a smart card and a flash memory device (e.g., an erasable programmable read-only memory (EPROM), a card, a stick or a key drive). The various computer-readable storage media described in the present disclosure may represent one or more devices and/or other machine-readable storage media for storing information. The term “machine-readable storage media” may include, but are not limited to, wireless channels and various other media capable of storing, containing, and/or carrying instruction(s) and/or data.

In the above description of the embodiments, specific features, structures, materials, or characteristics may be combined in a suitable manner in any one or more embodiments or examples.

It will be noted that any one of the technical solutions disclosed in the present disclosure may solve one or more of the technical problems described above to a certain extent and achieve the corresponding technical effects to a certain extent. Alternatively, a plurality of disclosed technical solutions may also be combined into an overall solution, so as to solve one or more of the technical problems described above and achieve the corresponding technical effects. Alternatively, some disclosed technical solutions may be combined into an overall solution, while adopting the related art and deteriorated solutions, but the solution may compensate the deterioration trend through the technological means of the present disclosure, so that on the whole, one or more of the technical problems described above may be solved to a certain extent and the corresponding technical effects may be achieved to a certain extent. Alternatively, each of the disclosed technical solutions forms a complete technical solution, and a plurality of complete technical solutions constitute an organic and inseparable overall solution, so that on the whole, the technical problems are solved and the corresponding technical effects are achieved.

Any one of the disclosed technical solutions disclosed in the present disclosure, as well as the recombination of the plurality of disclosed technical solutions in the present disclosure, each may form a complete technical solution and solve one or more of the technical problems described above and achieve the corresponding technical effects. They all belong to the content of the present disclosure and belong to the content that is directly and unambiguously determined according to the content of the present disclosure.

A person skilled in the art will understand that the scope of disclosure in the present disclosure is not limited to specific embodiments discussed above and may modify and substitute some elements of the embodiments without departing from the spirits of the present disclosure. The scope of the present disclosure is limited by the appended claims.

What is claimed is:

1. A laser projection apparatus, comprising:
a main control chip configured to generate a video signal according to an external video source;
a display driving assembly connected to the main control chip, a phase light modulation assembly, and a first light modulation device,
the display driving assembly being configured to obtain the video signal, send a synchronization signal to the phase light modulation assembly and send a first driving signal to the first light modulation device according to the video signal;
a laser source assembly configured to emit laser beams of a plurality of primary colors;
a laser driving assembly connected to the laser source assembly, the laser driving assembly being configured to obtain the synchronization signal and send a second driving signal to the laser source assembly according to the synchronization signal, so as to drive the laser source assembly to be turned on to emit the laser beams of the plurality of primary colors;
a video processing assembly connected to the main control chip and the phase light modulation assembly, the video processing assembly being configured to receive the video signal sent by the main control chip and send a phase video signal to the phase light modulation assembly according to the video signal;
the phase light modulation assembly configured to perform phase modulation according to the phase video signal and the synchronization signal, so as to output first modulated beams to the first light modulation device; and
the first light modulation device configured to modulate the first modulated beams to obtain second modulated beams, so as to project the second modulated beams for display.

2. The laser projection apparatus according to claim 1, wherein the video processing assembly is further configured to:
after obtaining a plurality of video sub-signals,
obtain luminance compensation parameters and luminance information of a plurality of sub-images in any one of the plurality of video sub-signals; the plurality of video sub-signals being obtained by decoding the video signal;
generate phase image information corresponding to the video sub-signal according to the luminance information of the plurality of sub-images and the luminance compensation parameters; and
generate the phase video signal according to the phase image information corresponding to the plurality of video sub-signals.

3. The laser projection apparatus according to claim 1, wherein the phase light modulation assembly includes:
a light modulation driving group connected to the video processing assembly, the display driving assembly, and a second light modulation device, the light modulation driving group being configured to send a third driving signal to the second light modulation device according to the phase video signal and the synchronization signal; and
the second light modulation device configured to perform phase modulation according to the third driving signal, so as to output the first modulated beams to the first light modulation device.

4. The laser projection apparatus according to claim 3, wherein the synchronization signal includes an enable signal and a pulse width modulation (PWM) signal;
the light modulation driving group is configured to:
obtain a bias voltage of the second light modulation device according to the enable signal; and
send the third driving signal to the second light modulation device according to the enable signal, the PWM signal and the phase video signal; wherein the third driving signal includes the bias voltage;
the second light modulation device is configured to:
control displacement of mirrors of the second light modulation device according to the bias voltage, so as to perform phase modulation on the laser beams of the plurality of primary colors through the displaced mirrors.

5. The laser projection apparatus according to claim 4, wherein the light modulation driving group includes:
a light modulation driving component connected to the video processing assembly, the display driving assembly, and the second light modulation device, the light modulation driving component being configured to receive the phase video signal sent by the video processing assembly and the synchronization signal sent by the display driving assembly, and send the phase video signal to the second light modulation device according to the synchronization signal; and
a bias voltage conversion circuit connected to the display driving assembly and the second light modulation device, the bias voltage conversion circuit being configured to receive the enable signal sent by the display driving assembly and send the bias voltage to the second light modulation device according to the enable signal.

6. The laser projection apparatus according to claim 4, wherein the light modulation driving group includes:
a light modulation driving component connected to the video processing assembly, the display driving assembly, and the second light modulation device, the light modulation driving component being configured to receive the phase video signal sent by the video processing assembly and the synchronization signal sent by the display driving assembly, and send the phase video signal to the second light modulation device according to the synchronization signal; and
a bias voltage conversion circuit connected to the display driving assembly, the laser driving assembly, and the second light modulation device, the bias voltage conversion circuit being configured to:
receive the enable signal and the PWM signal sent by the display driving assembly;
send the bias voltage to the second light modulation device according to the enable signal; and
perform digital-to-analog conversion on the PWM signal, and send an analog signal corresponding to the PWM signal to the laser driving assembly.

7. The laser projection apparatus according to claim 6, wherein the bias voltage conversion circuit includes a first digital-to-analog converter, the first digital-to-analog converter is connected to the display driving assembly and the laser driving assembly, and the first digital-to-analog converter is configured to: receive the PWM signal sent by the display driving assembly, perform digital-to-analog conversion on the PWM signal, and send the analog signal corresponding to the PWM signal to the laser driving assembly.

8. The laser projection apparatus according to claim 5, wherein the bias voltage conversion circuit includes:
a plurality of voltage regulators configured to send target voltages corresponding to the laser beams of the plurality of primary colors to an analog switch; the target voltages sent by the plurality of voltage regulators being different; and
the analog switch connected to the plurality of voltage regulators, the display driving assembly and the second light modulation device, the analog switch being configured to receive the enable signal sent by the display driving assembly, obtain the bias voltage from the target voltages corresponding to the laser beams of the plurality of primary colors according to the enable signal, and send the bias voltage to the second light modulation device.

9. The laser projection apparatus according to claim 8, further comprising a power supply, wherein the bias voltage conversion circuit further includes a direct current-direct current (DC/DC) converter, the DC/DC converter is connected to the power supply and the plurality of voltage regulators, the DC/DC converter is configured to input a second driving voltage to the plurality of voltage regulators according to a first driving voltage input from the power supply; and
any one of the plurality of voltage regulators is configured to input the target voltage to the analog switch according to the second driving voltage.

10. The laser projection apparatus according to claim 5, wherein the bias voltage conversion circuit includes:
a control assembly connected to the display driving assembly and a second digital-to-analog converter, the control assembly being configured to receive the enable signal sent by the display driving assembly and input a target voltage corresponding to the laser beams of any one of the plurality of primary colors to the second digital-to-analog converter according to the enable signal;
the second digital-to-analog converter configured to convert the target voltage into a voltage analog signal; and
an amplifier connected to the second digital-to-analog converter and the second light modulation device, the amplifier being configured to send the bias voltage to the second light modulation device according to the voltage analog signal.

11. The laser projection apparatus according to claim 10, wherein the control assembly is further configured to output a preset voltage signal;
the amplifier is further configured to adjust the bias voltage to obtain a processed bias voltage according to the preset voltage signal, and send the processed bias voltage to the second light modulation device;
wherein the preset voltage signal is configured to control the bias voltage to vary within a target voltage range.

12. The laser projection apparatus according to claim 10, wherein the amplifier is connected to the control assembly and configured to send the bias voltage to the control assembly; and
the control assembly is further configured to correct the target voltage corresponding to subsequent primary color laser beams in the laser beams of the plurality of primary colors according to the bias voltage.

13. The laser projection apparatus according to claim 12, wherein the control assembly is further configured to:
obtain a first moment when the amplifier outputs a bias voltage corresponding to current primary color laser beams;
obtain a second moment when the display driving assembly outputs an enable signal corresponding to the current primary color laser beams;
obtain a preset duration according to the first moment and the second moment; and
delay output time of an enable signal corresponding to the subsequent primary color laser beams by the preset duration.

14. The laser projection apparatus according to claim 1, wherein the video processing assembly is configured to:
obtain a plurality of video sub-signals; the plurality of video sub-signals being obtained by decoding the video signal;
determine a phase information signal corresponding to any one of the plurality of video sub-signals according to the any one of the plurality of video sub-signals; and
determine the phase video signal according to the phase information signals corresponding to the plurality of video sub-signals.

15. The laser projection apparatus according to claim 14, wherein the video processing assembly includes:
a first sub-frame decoding component connected to the main control chip, the first sub-frame decoding component being configured to obtain the video signal and decode the video signal to obtain the plurality of video sub-signals; and
a first phase retrieval processing component connected to the first sub-frame decoding component, the first phase retrieval processing component being configured to obtain the plurality of video sub-signals and determine the phase information signal corresponding to any one of the plurality of video sub-signals according to the plurality of video sub-signals.

16. The laser projection apparatus according to claim 15, wherein the video processing assembly further includes a bypass video signal output component, the bypass video signal output component is connected to the main control chip, the first sub-frame decoding component, and the display driving assembly, and configured to:
receive the video signal;
transmit the video signal along two channels; and
output a video signal in a first channel of the two channels to the first sub-frame decoding component, and a video signal in a second channel of the two channels to the display driving assembly.

17. The laser projection apparatus according to claim 15, wherein the first sub-frame decoding component is further configured to:
obtain a preset resolution of a second light modulation device of the phase light modulation assembly;
compress an image in the video signal having a resolution higher than the preset resolution, so as to make a resolution of the compressed image equal to the preset resolution.

18. The laser projection apparatus according to claim 14, wherein
the main control chip includes a second sub-frame decoding component, and the second sub-frame decoding component is configured to generate the plurality of video sub-signals according to the video signal and output the plurality of video sub-signals to the video processing assembly; and
the video processing assembly includes a second phase retrieval processing component, the second phase retrieval processing component is connected to the second sub-frame decoding component, and configured to obtain the plurality of video sub-signals and determine the phase information signal corresponding to any one of the plurality of video sub-signals according to the plurality of video sub-signals.

19. An image display method of a laser projection apparatus, wherein the laser projection apparatus includes:
a main control chip;
a display driving assembly connected to the main control chip, a laser driving assembly, a phase light modulation assembly and a first light modulation device;
a laser source assembly configured to emit laser beams of a plurality of primary colors;
the laser driving assembly connected to the laser source assembly;
a video processing assembly connected to the main control chip and the phase light modulation assembly;
the phase light modulation assembly configured to perform phase modulation on the laser beams of the plurality of primary colors to provide first modulated beams; and
the first light modulation device configured to modulate the first modulated beams;
the method comprises:
obtaining, by the display driving assembly, a video signal, and sending a synchronization signal to the laser driving assembly and the phase light modulation assembly and sending a first driving signal to the first light modulation device according to the video signal;
determining, by the laser driving assembly, a second driving signal according to the synchronization signal, and driving the laser source assembly to be turned on according to the second driving signal, so as to emit the laser beams of the plurality of primary colors to the phase light modulation assembly;
obtaining, by the video processing assembly, luminance compensation parameters, and sending a phase video signal to the phase light modulation assembly according to the luminance compensation parameters and the video signal;
obtaining, by the phase light modulation assembly, a bias voltage according to the synchronization signal, and performing phase modulation according to the phase video signal and the bias voltage, so as to output the first modulated beams to the first light modulation device; and
modulating, by the first light modulation device, the first modulated beams to display an image.

20. The image display method of the laser projection apparatus according to claim 19, further comprising:
obtaining, by a control assembly of the phase light modulation assembly, the bias voltage, and correcting a target voltage corresponding to subsequent primary color laser beams in the laser beams of the plurality of primary colors according to the bias voltage.
